(19) United States
(12) Patent Application Publication
(10) Pub. No.: US 2014/0245300 A1
(43) Pub. Date: Aug. 28, 2014

(54) Dynamically Balanced Credit for Virtual Functions in Single Root Input/Output Virtualization

(71) Applicant: LSI CORPORATION, San Jose, CA (US)

(72) Inventors: Roger T. Clegg, Wichita, KS (US); Peter C. Rivera, Colorado Springs, CO (US); Brad D. Besmer, Colorado Springs, CO (US); Steven R. Schremmer, Wichita, KS (US)

(73) Assignee: LSI Corporation, San Jose, CA (US)

(21) Appl. No.: 13/781,848

(22) Filed: Mar. 1, 2013

Related U.S. Application Data
(60) Provisional application No. 61/769,843, filed on Feb. 27, 2013.

(51) Int. Cl. G06F 9/455

(52) U.S. Cl. CPC G06F 9/45533
USPC 718/1

(57) ABSTRACT

A system to allow reallocation of credit among virtual machines associated with separate operating systems includes drivers in each virtual machine to independently track credit usage and a host board adapter configured to report a false maximum to each operating system and track credit usage. The host board adapter allocates credits and reports the allocated credits to virtual functions accessed by the virtual machines. A hypervisor reallocates credits by reporting the new allocation to the host board adapter and consequently to each virtual function and each associated virtual machine. Each operating system maintains resources defined by the false maximum and never knows about the reallocation.

### PRIORITY

The present application claims the benefit under 35 U.S.C. §119(e) of U.S. Provisional Application Ser. No. 61/769,843, filed Feb. 27, 2013, which is incorporated herein by reference.

### BACKGROUND OF THE INVENTION

Credits are a mechanism of flow control between a host and input/output controller to prevent overflow of request queues. The input/output controller allocates credits to a host driver by reporting the allocated credit in a message. The amount of credit allocated to the host driver can change across power cycles or system-level resets but cannot change during run-time. The host driver is responsible for ensuring the number of outstanding request messages does not exceed the number of credits.

Each time the host driver sends a message it reduces the available credit count. The host driver increments the credit count by one each time it receives a reply to an outstanding message. If the host driver has exhausted its credit count, the host must wait until credits are available before posting another message.

One aspect of single root input/output virtualization is that each virtual machine (usually represented by a single processor or thread) in a multiprocessor system is assigned to a virtual function for the purpose of providing multiple operating system/server instances, each of which run virtually independently of the others. Each virtual function in the system may have a different number of credits, the one that needs highest performance having the largest number of credits and the lowest priority having fewer credits.

In the most flexible environments, virtual functions can move from one processor to another and therefore dynamic configuration of the system is necessary. Reconfiguring the input/output device and resetting all the virtual machines is not an adequate solution as it would interrupt processing on all the servers. The best solution would be to provide a mechanism to vary the credit dynamically based upon an administrator's desire.

Consequently, it would be advantageous if an apparatus existed that is suitable for dynamically allocating credits in a message passing system.

### SUMMARY OF THE INVENTION

Accordingly, the present invention is directed to a novel method and apparatus for dynamically allocating credits in a message passing system.

One embodiment of the present invention is a computing device executing two or more virtual machines associated with two or more operating systems. Each virtual machine and operating system receives a false maximum credit value at startup. The virtual machines include drivers to track credit usage independently of the associated operating systems. The computing device includes a hypervisor that reallocates credits by instructing the virtual machines of the new credit allocation and queuing messages as appropriate.

Another embodiment of the present invention is a host board adapter with one or more physical functions and one or more virtual functions and a host with multiple logical central processing units. A hypervisor sends a message to the host board adapter giving it instructions to reallocate credits among the two or more virtual functions. The host board adapter then communicates the new credit allocations to associated virtual machines via the virtual functions. The virtual functions track credit usage and the virtual machines queue messages as appropriate when credit reallocation produces an inconsistency in the number of outstanding messages as compared to the number of available credits.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a block diagram of a system having more than one virtual machine and more than one virtual function utilizing a credit based methodology;

FIG. 2 shows a flowchart of a method for a hypervisor to dynamically allocate credits; and

FIG. 3 shows a flowchart of a method for a host board adapter to dynamically allocate credits;

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

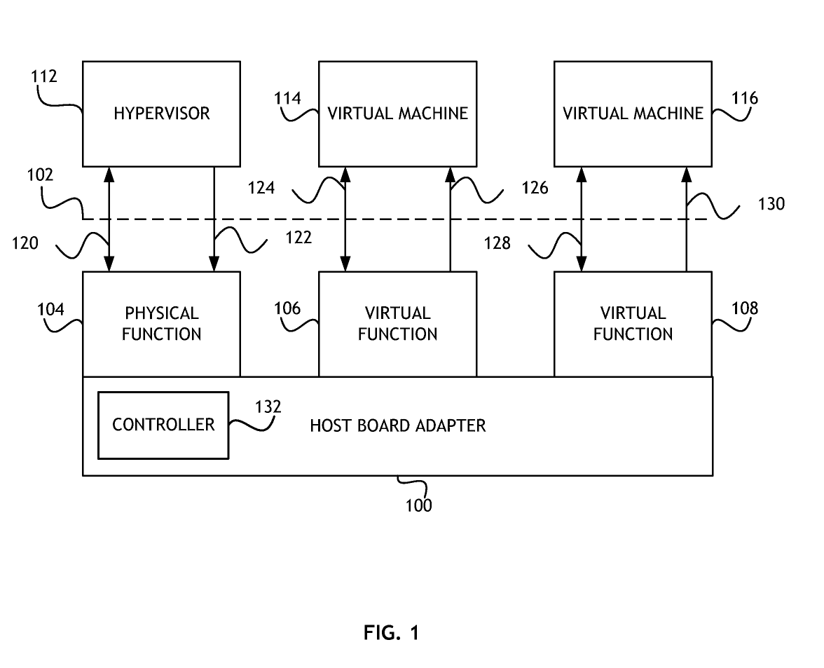

Referring to FIG. 1, a block diagram of a system having more than one virtual machine and more than one virtual function utilizing a credit based methodology is shown. The system allocates credits dynamically by establishing a maximum credit value for each operating system and one or more queues for credit tracking. In at least one embodiment of the present invention, the system includes a host board adapter 100 with one or more input/output processors 132. The host board adapter 100 has access to resources such as disk drives and Ethernet PHYs (not shown) that the host board adapter 100 makes accessible to other connected devices. In at least one embodiment of the present invention, the host board adapter 100 has access to one or more physical functions 104. In at least one embodiment of the present invention, physical functions 104 are PCIe functions that are visible to a root PCIe controller by default; physical functions 104 include mechanisms for tracking credits. In at least one embodiment of the present invention, the host board adapter 100 also has access to one or more virtual functions 106, 108. Each of the one or more virtual functions 106, 108 includes a mechanism, through at least one associated driver, for tracking credits. The mechanism for tracking credits includes a data structure such as a queue; whenever a driver associated with a virtual function 106, 108 sends a message, the message is added to the queue and the number of available credits is reduced. When a response to a message in a queue is received by a driver associated with a virtual function 106, 108, the message is removed from the queue and the number of available credits is increased. Each physical function 104 and virtual function 106, 108 includes a driver configured to communicate with the input/output processor 132. The one or more input/output processors 132 are configured to report an initial false maximum credit limit to each physical function 104 and virtual function 106, 108, through an associated driver, at a startup time so that each physical function 104 and virtual function 106, 108 can report such false maximum credit limit, through an associated driver, to one or more operating systems, virtual machines or hypervisors.

Each physical function 104 and virtual function 106, 108 is associated with an actual credit limit. The actual credit limit for each virtual function 106, 108 can and usually will be less than the false maximum number of credits reported to virtual machines and operating systems associated with each physical function 104 and virtual function 106, 108. The actual credit limit for each of the physical functions 104 and virtual functions 106, 108 can be dynamically altered at any time without changing the maximum number of credits reported to any operating system. In at least one embodiment of the present invention, virtual functions 106, 108 are a set of PCIe defined hardware registers available to the one or more input/output processors 132 such that an operating system exposes such hardware registers to a virtual machine as if they were physical functions 104.

In at least one embodiment of the present invention, one or more processors are connected to the host board adapter 100 through a PCIe interface 102. The processors instantiate one or more virtual machines 114, 116 and at least one hypervisor 112. A virtual machine 114, 116 is a virtual environment in which an operating system runs as if it were running by itself. A single physical machine may simultaneously house more than one virtual machine 114, 116. A hypervisor 112 is a construct that controls virtual and real access to system resources in order to provide the capability to run virtual machines 114, 116. The at least one hypervisor 112 manages resource allocation to the one or more virtual machines 114, 116. In at least one embodiment, the hypervisor 112 initializes one or more physical functions 104 associated with the host board adapter 100 through a data pathway 120 configured to allow drivers in the hypervisor 112 to communicate with the host board adapter 100. In at least one embodiment, the hypervisor 112 also discovers one or more virtual functions 106, 108 available through the host board adapter 100. The hypervisor 112 assigns certain of the one or more virtual functions 106, 108 to certain of the one or more virtual machines 114, 116. Assigning virtual functions 106, 108 may include assigning host board adapter 100 available resources such as disk drives and Ethernet PHYs.

In a system utilizing credits to control outstanding messages, a processor executing one or more virtual machines 114, 116 will expect a credit value at boot time. Existing operating system and host adapter architecture do not support changes to the credit value. In at least one embodiment of the present invention, at boot time, a false maximum number of credits is reported to each virtual machine 114, 116, and each virtual machine 114, 116 allocates resources appropriate to handle the false maximum number of credits. Virtual functions 106, 108 associated with a virtual machine 116, 118 will include drivers having independent credit tracking mechanisms to establish an actual credit limit for each virtual function 106, 108 that does not exceed the false maximum number of credits reported to the corresponding virtual machine 114, 116.

In one embodiment, the hypervisor 112 includes drivers for communicating with one or more physical functions 104, or with drivers associated with one or more physical functions 104, regarding changes to a corresponding actual credit limit. At boot time, drivers associated with the one or more physical functions 104 communicate with the input/output processor 132 to discover the false maximum credit limit. In at least one embodiment, the hypervisor 112 loads drivers and discovers, through the one or more physical functions 104, the false maximum number of credits. Alternatively, the hypervisor 112 is unaware of the false maximum credit limit. In either embodiment, the hypervisor can order a reallocation of credits; changing the actual credit limits associated with at least one of the one or more physical functions 104 and virtual functions 106, 108.

Each physical function 104 and virtual function 106, 108 includes a driver to query and receive a false maximum credit limit from the host board adapter 100. The hypervisor 112 initializes one or more virtual machines 114, 116. Each of the one or more virtual machines 114, 116 includes a driver configured to communicate with an assigned virtual function 104, 106 and receive a credit limit from the input/output processor 132 via the virtual function 104, 106; at startup, each virtual function 104, 106 reports the false maximum credit limit. The one or more virtual machines 114, 116 then boot a corresponding operating system and the corresponding operating system discovers, through drivers associated with the physical functions 104 and virtual functions 106, 108, the maximum number of credits allocated to the processor executing each of the one or more virtual machines 114, 116. In at least one embodiment, each physical function 104 has a separate credit based mechanism. Each virtual function 106, 108 communicates with the host board adapter 100 to determine the number of available credits.

After the hypervisor 112, virtual machines 114, 116 and corresponding operating systems are initialized and resources are allocated according to the false maximum credit limit, the input/output processor 132 reports an actual or functional credit value to drivers associated with each physical function 104 and virtual function 104, 106. Each actual credit value is then reported to the hypervisor 112 and each virtual machine 114, 116. The actual credit value is used by drivers in each virtual machine 114, 116 and each virtual function 104, 106 and physical function 104 to manage credit usage. Each actual credit value may be a default credit value or some persistent credit value stored and used by the input/output processor 132.

In one exemplary embodiment, drivers associated with a first virtual machine 114 communicate with drivers associated with a first virtual function 106 and drivers associated with a second virtual machine 116 communicate with drivers associated with a second virtual function 108. The host board adapter 100 allocates credits to each of the first virtual machine 112 and second virtual machine 116 according to some default values and communicates such values to drivers associated with one or more physical function 104 and one or more virtual function 106, 108. For example, the host board adapter 100 initially reports one hundred ninety-five total credits to each driver. In at least one embodiment, the host board adapter 100 also reports a maximum and minimum credit value that will be used by each physical function 104 and virtual function 106, 108 to actually control credit usage. Each physical function 104 and virtual function 106, 108 reports the false maximum to each associated operating system at the time such operating system boots. The false maximum may be the total number of available credits, or some subset of the total number of available credits, even though the total number of available credits must necessarily be divided among more than one operating system. Each virtual machine 114, 116 allocates memory and resources to accommodate the false maximum.

The host board adapter 100 configures each virtual function 106, 108 for the maximum number of credits that will ever be configured. If the host board adapter 100 cannot process a given input/output immediately after initialization, the host board adapter 100 queues the input/outputs internally until such time as the actual intended credits are configured by the administrator. Once the host board adapter 100 is initialized and configured it sends an event to each virtual function 106, 108, or drivers associated with the virtual functions 106, 108, indicating the actual number of credits that are allocated on the card. The actual credit value is the number of input/outputs that the device is allowed to have processing at a given time. The host board adapter 100 then restricts the number of requested input/outputs to a number corresponding to the actual credit value, queuing any that are outstanding. Likewise, each driver associated with a physical function 104 or virtual function 106, 108 would stop issuing input/output commands until the number of outstanding input/output requests dropped below the credit limit.

In at least one embodiment of the present invention, credits are allocated to the virtual functions 106, 108 based a priority. The host board adapter 100 communicates the allocated credits to each virtual function 106, 108; for example, the first virtual function 106 is allocated one hundred thirty-five credits and the second virtual function 108 is allocated sixty credits. Whenever a virtual machine 114, 116 associated with one of the virtual functions 106, 108 sends a message that will be handled by the host board adapter 100, the virtual function 106, 108 or drivers associated with the virtual functions 106, 108, and drivers associated with the virtual machine 114, 116 track such credit use. Virtual machines 114, 116 can continue to send messages as long as the virtual machine 114, 116 has available credits. If an operating system attempts to send a message when it has no available credits, the driver associated with the appropriate virtual machine 114, 116 must queue such messages until the virtual machine 114, 116 receives a response to one of the outstanding messages and thereby frees a credit.

When changes occur in the priority of execution of the one or more virtual functions 106, 108 or virtual machines 114, 116, credits are reallocated to favor the higher priority virtual function 106, 108 or virtual machine 114, 116. In at least one embodiment of the present invention, credits are reallocated by the hypervisor 112. Upon determining that reallocation is necessary, the hypervisor 112 sends a message to the host board adapter 100 through an appropriate data pathway 122 indicating a credit reallocation. In at least one embodiment, such data pathway includes a driver associated with a physical function 104. For example, continuing with the previously described allocation, the hypervisor 112 determines that the first virtual function 106 should be allocated sixty credits instead of one hundred thirty-five, and that the second virtual function 108 should be allocated one hundred thirty-five credits instead of sixty. The hypervisor 112 communicates the new allocation to the host board adapter 100 through in-channel communication mechanisms and the host board adapter 100 communicates the new allocation to drivers associated with each virtual function 106, 108. Each virtual function 106, 108, or associated driver, then sends an update to the corresponding virtual machine 114, 116 through appropriate data pathways 126, 130. Drivers in each virtual machine 114, 116 then update an appropriate data structure indicating the number of credits available to the virtual machine 114, 116 regardless of the false maximum allocated by the corresponding operating system.

If, at a future time the credit value increases or decreases for a particular virtual machine 114, 116 or virtual function 106, 108, another message will be sent to a driver associated with the virtual machine 116, 118 or virtual function 106, 108 which must then adjust to the new credit value. In at least one embodiment of the present invention, the host board adapter 100 includes an input/output processor 132 configured to receive messages from the hypervisor 112 indicating a change to credit allocation. The host board adapter 100 then sends a message to the virtual machine 114, 116 or virtual function 106, 108, or associated drivers, indicating the new credit value for such virtual machine 114, 116 or virtual function 106, 108.

Where a reallocation increases available credits for a virtual machine 114, 116 or virtual function 106, 108, the virtual machine 114, 116 or virtual function 106, 108, or an associated driver, sends messages previously queued for lack of available credits. Where the reallocation decreases available credits for a virtual machine 114, 116 or virtual function 106, 108, and the virtual machine 114, 116 or virtual function 106, 108 is associated with more outstanding messages than the reallocated number of credits, the virtual machine 114, 116 or virtual function 106, 108, or an associated driver, will queue any new messages until the number of outstanding messages drop to below the number of reallocated credits.

In at least one embodiment of the present invention, drivers for the host board adapter 100, virtual machines 114, 116 and virtual functions 106, 108 overprovision communication buffers and queues to account for a maximum credit value and a minimum credit value. Resources are allocated on the basis of a range of credit values. Overprovisioning in the drivers ensures the drivers can allocate enough memory at the start-of-day to accommodate the maximum credit value. Over provisioning in the host board adapter 100 queues at start-of-day ensures that the host board adapter 100 will have sufficient resources to handle the maximum credit for the given functions.

In at least one embodiment of the present invention, overprovisioning is done with queues so the extra memory requirement is minimal. The message passing interface hardware in the host board adapter 100 handles transitions necessary when the queues change sizes. If no resources are available for direct memory access of requests posted before the credit value change was executed, queues will wait for resources to become available, but messages will not be lost.

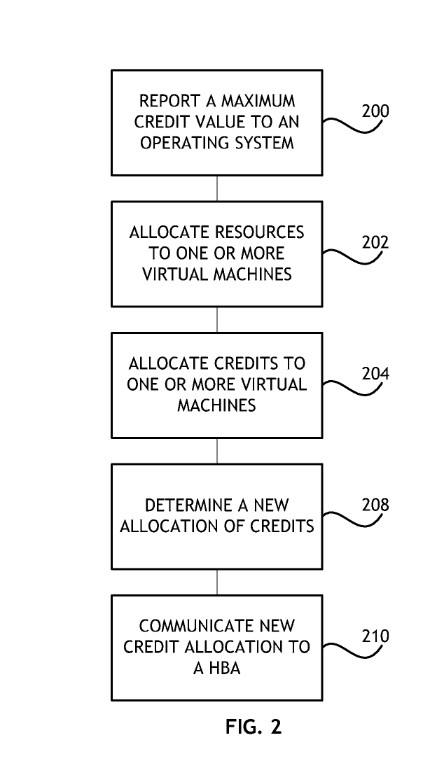

Referring to FIG. 2, a flowchart of a method for a hypervisor to dynamically allocate credits is shown. In at least one embodiment of the present invention, a host board adapter reports 200 a maximum credit value to one or more operating systems associated with one or more virtual machines. The maximum credit value is a credit value greater than any one virtual machine is likely to actually have at any given time. A hypervisor then allocates 202 resources to virtual machines and virtual functions sufficient to accommodate the maximum credit value.

In at least one embodiment of the present invention, the host board adapter allocates 204 credits to one or more virtual functions. Each virtual function is allocated 204 fewer than the maximum credit value reported to the one or more operating systems. Drivers associated with each virtual function include mechanisms for tracking credit usages and for implementing actual maximum and minimum credit values. Credits may be allocated according to a priority ranking of the virtual functions.

In at least one embodiment of the present invention, when a hypervisor determines that credits should be reallocated, the hypervisor determines 208 a new allocation of credits among virtual machines or virtual functions. Credits may need to be reallocated when a virtual machine or virtual function is associated with a disproportionate number of queued messages, when the priority of a particular virtual machine or virtual function changes over time, or any other such eventuality. In at least one embodiment of the present invention, reallocation includes reducing the number of credits associated with one virtual machine of virtual function, and increasing the number of credits associated with another virtual machine or virtual function. The number of credits associated with any one virtual machine or virtual function will not exceed the maximum credit value reported to one or more operating systems executing each virtual machine.

The hypervisor then communicates 210 the new credit allocation the host board adapter through drivers associated with one or more physical functions. The host board adapter communicates new credit values to each virtual function through a driver associated with such virtual function. Where a virtual function has outstanding messages in excess of the new credit value associated with that virtual function, the virtual function begins queuing new messages until the virtual function receives enough return messages to bring the number of outstanding messages below the new credit value for the virtual function. Likewise, where a virtual function has queued messages because the prior credit value for that virtual function was greater than or equal to the number of outstanding messages, and that credit value is increased during reallocation, the virtual function, or a driver associated with the virtual function, begins processing queued messages until the queue is cleared or the new credit value is reached.

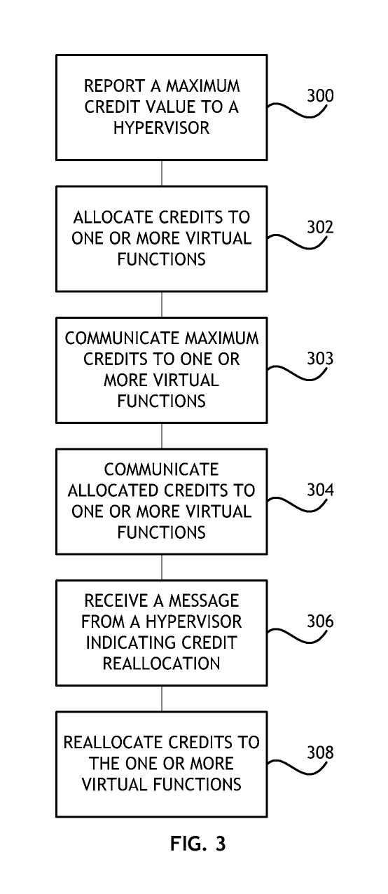

Referring to FIG. 3, a flowchart of a method for a host board adapter to dynamically allocate credits is shown. In at least embodiment of the present invention, a host board adapter reports 300 a maximum credit one or more operating systems through one or more physical or virtual functions, or associated drivers. The maximum credit value is a value reported to one or more operating systems so that the operating systems can allocate enough local resources to accommodate a number of outstanding messages up to the maximum credit value. In at least one embodiment, the maximum credit value is a default value based on the resources available to the host board adapter. The maximum credit value is some value not exceeding the total number of credits available for the host board adapter to allocate. In any event, the maximum credit value is the maximum number of credits that can be allocated by the host board adapter to the operating system, a virtual machine associated with the operating system or a virtual function utilized by a virtual machine executing on the operating system.

The host board adapter also allocates 302 credits to one or more virtual functions. The host board adapter may allocate 302 credits based on some default setting or on some persistent quantity. The host board adapter communicates 303 the maximum credit value to the one or more virtual functions and physical functions. The one or more virtual functions and physical functions then report the maximum credit value to each operating system. The host board adapter then communicates 304 the allocated credits to the one or more virtual functions, or drivers associated with the one or more virtual functions. Drivers in each virtual function track the maximum and allocated credit values and credit usage. In at least one embodiment of the present invention, each virtual function communicates the allocated credit value to an associated virtual machine. Each virtual function, virtual machine and host board adapter includes drivers to handle credit values, separate from credit handling functionality in each associated operating system.

When circumstances indicate a need to reallocate credits, the hypervisor sends a message through in-channel mechanisms to the host board adapter. The host board adapter, receiving 306 such message indicating a reallocation or credits, calculates a new allocation according to some appropriate criteria. For example, the host board adapter may determine a reallocation based on queued messages. The host board adapter then reallocates 308 credits by communicating the new allocation to each virtual function or drivers associated with such virtual function. In at least one embodiment of the present invention, each virtual function communicates the new allocation to an associated virtual machine.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A computer system comprising:
at least one processor, the at least one processor configured to execute at least two operating systems, a first operating system of the at least two operating systems associated with a first virtual machine and a second operating system of the at least two operating systems associated with a second virtual machine, and the at least one processor further configured to execute a hypervisor;
a memory connected to the processor;
a host board adapter connected to the processor;
computer executable program code associated with the processor; and
computer executable program code associated with the host board adapter,
wherein the computer executable program code associated with host board adapter is configured to:
report a maximum credit value to each of the at least two operating systems;
allocate a first credit value to a first virtual machine and a second credit value to a second virtual machine; and
report the first credit value and the second credit value to the hypervisor; and
wherein the maximum credit value is greater than either the first credit value or the second credit value.

2. The computer system of claim 1, wherein the computer executable program code associated with the host board adapter is configured to receive a request for the maximum credit value from at least one virtual function.

3. The computer system of claim 1, wherein each of the first virtual machine and second virtual machine is configured to track a credit usage based on an outstanding message count, independent of the associated operating system.

4. The computer system of claim 1, wherein:
the computer executable program code associated with the processor is configured to:
analyze one or more credit usage parameters;
determine a third credit value associated with the first virtual machine and a fourth credit value associated with the second virtual machine based on the one or more credit usage parameters; and
communicate the third credit value and the fourth credit value to the host board adapter;
the computer executable program code associated with the host board adapter is configured to communicate the third credit value to the first virtual machine and the fourth credit value to the second virtual machine; and
wherein:
the third credit value is different from the first credit value;
the fourth credit value is different from the second credit value; and
the maximum credit value is greater than both the third credit value and the fourth credit value.

5. The computer of claim 4, wherein the first virtual machine is configured to queue one or more new messages when a number of outstanding messages associated with the first virtual machine is greater than the third credit value.

6. The computer system of claim 4, wherein the second virtual machine is configured to execute one or more queued messages associated with the second virtual machine when the second virtual machine is associated with fewer outstanding messages than the fourth credit value.

7. The computer system of claim 1, wherein the computer executable program code associated with the host board adapter is configured to:
receive a reallocation signal from the hypervisor;
determine a third credit value associated with a first virtual function and a fourth credit value associated with a second virtual function; and
communicate the third credit value to the first virtual function and the fourth credit value to the second virtual function; and
wherein:
the third credit value is different from the first credit value;
the fourth credit value is different from the second credit value; and
the maximum credit value is greater than both the third credit value and the fourth credit value.

8. The computer system of claim 7, wherein the computer executable program code associated with the host board adapter is further configured to queue one or more new messages associated with the first virtual function when a number of outstanding messages associated with the first virtual function is greater than the third credit value.

9. A computer apparatus comprising:
at least one processor, the at least one processor configured to execute at least two operating systems, a first operating system of the at least two operating systems associated with a first virtual machine and a second operating system of the at least two operating systems associated with a second virtual machine;
a memory connected to the processor;
computer executable program code configured to execute on the processor,
wherein the computer executable program code is configured to:
receive a maximum credit value associated with each of the at least two operating systems; and
receive a first credit value associated with the first virtual machine and a second credit value associated with the second virtual machine.

10. The computer apparatus of claim 9, wherein each of the first virtual machine and second virtual machine is configured to track a credit usage based on an outstanding message count, independent of the associated operating system.

11. The computer apparatus of claim 9, wherein the computer executable program code is configured to:
analyze one or more credit usage parameters;
determine a third credit value associated with the first virtual machine and a fourth credit value associated with the second virtual machine based on the one or more credit usage parameters; and
communicate the third credit value and the fourth credit value to a host board adapter; and
wherein:
the third credit value is different from the first credit value;
the fourth credit value is different from the second credit value; and
the maximum credit value is greater than both the third credit value and the fourth credit value.

12. The computer apparatus of claim 11, wherein the first virtual machine is configured to queue one or more new messages when a number of outstanding messages associated with the first virtual machine is greater than the third credit value.

13. The computer apparatus of claim 11, wherein the second virtual machine is configured to execute one or more queued messages associated with the second virtual machine when the second virtual machine is associated with fewer outstanding messages than the fourth credit value.

14. A host board adapter comprising:
a processor, the processor configured to execute at least two virtual functions;
a memory connected to the processor; and
computer executable program code configured to execute on the processor,
wherein the computer executable program code is configured to:
report a maximum credit value to one or more virtual functions;
allocate a first credit value to a first virtual function; and
allocated a second credit value to a second virtual function; and
wherein the maximum credit value is greater than both the first credit value and the second credit value.

15. The host board adapter of claim 14, wherein the computer executable program code is configured to receive a request for the maximum credit value from at least one virtual function.

16. The host board adapter of claim 14, wherein:
the first virtual function is configured to communicate the first credit value to a virtual machine; and
the second virtual function is configured to communicate the second credit value to a virtual machine.

17. The host board adapter of claim 14, wherein the computer executable program code is configured to:
receive a reallocation signal;
determine a third credit value associated with the first virtual function and a fourth credit value associated with the second virtual function; and
communicate the third credit value to the first virtual function and the fourth credit value to the second virtual function; and
wherein:
the third credit value is different from the first credit value;
the fourth credit value is different from the second credit value; and
the maximum credit value is greater than both the third credit value and the fourth credit value.

18. The host board adapter of claim 17, wherein:
the first virtual function is configured to communicate the third credit value to a virtual machine; and
the second virtual function is configured to communicate the fourth credit value to a virtual machine.

19. The host board adapter of claim 18, wherein the first virtual function is configured to queue one or more new messages when a number of outstanding messages associated with the first virtual function is greater than the third credit value.

20. The host board adapter of claim 18, wherein the second virtual function is configured to execute one or more queued messages associated with the second virtual function when the second virtual function is associated with fewer outstanding messages than the fourth credit value.
